(19) United States
(12) Patent Application Publication
(10) Pub. No.: US 2025/0170022 A1
(43) Pub. Date: May 29, 2025

(54) FLUIDIC ANALYSIS AND CONTROL THROUGH IMAGE PROCESSING

(71) Applicant: Flextronics AP, LLC, San Jose, CA (US)

(72) Inventors: Olvik Josh, Haifa (IL); Ohad Zino, Haifa (IL); Ofer Braun, Haifa (IL); Offir Duman, Haifa (IL); Shaul Levy, Haifa (IL); Guil Felzenswalbe, Haifa (IL); Boaz Kalisch, Haifa (IL)

(73) Assignee: Flextronics AP, LLC, San Jose, CA (US)

(21) Appl. No.: 18/958,075

(22) Filed: Nov. 25, 2024

Related U.S. Application Data
(60) Provisional application No. 63/603,415, filed on Nov. 28, 2023.

(51) Int. Cl. A61J 1/20

(52) U.S. Cl. CPC A61J 1/2003

(57) ABSTRACT

A fluid analysis system for analyzing and controlling fluid transfer. The fluid analysis system can include a controller, an optical device, a light source, and a fluid channel. The controller can be communicatively coupled to the optical device. The light source can be disposed adjacent the optical device. The light source can be configured to produce light in a viewing zone of the optical device, such that the optical device can capture the light produced by the light source. The fluid channel can be disposed adjacent the optical device and within the viewing zone of the optical device, and the fluid channel can be configured to provide a fluid flow path. The controller is configured to store and analyze images provided by the optical device to identify characteristics of a fluid flowing through the fluid channel.

### CROSS REFERENCE TO RELATED APPLICATIONS

This application claims the benefit of U.S. Provisional Application No. 63/603,415 filed on Nov. 28, 2023, which is incorporated by reference as if fully set forth.

### FIELD OF THE INVENTION

The present disclosure is directed to a system and method for fluid analysis and control, and more particularly it is directed to a system and method for medical fluid analysis and control using image processing.

### BACKGROUND OF THE INVENTION

In the medical industry, fluids (i.e., liquids) can be transferred to a patient to administer specific fluids to improve the patients' health and to prevent pain, among other medical uses. The fluids that can be transferred include nutrients, medication, and pain relievers, among other fluids not specifically listed. Traditionally, to control the amount of fluid that is delivered, an electrical connection needs to be established between a controller and the fluid source (e.g., cartridge, tube, bag, etc.). More specifically, an electrical connection needs to be established with an electrode positioned within or fluidly coupled to the fluid source to monitor and control the amount of fluid transferred and administered to the patient. An issue with the traditional approach is the electrodes are in direct contact with the fluid and each fluid source must include the electrodes, which increases the overall cost and complexity of the fluid transfer system. As such, there is a need for a new approach to monitoring and controlling fluid transfer in the medical industry.

### SUMMARY OF THE INVENTION

According to one aspect, a fluid analysis system for analyzing and controlling fluid transfer is disclosed. The fluid analysis system can include a controller, an optical device, a light source, and a fluid channel. The controller can be communicatively coupled to the optical device. The light source can be disposed adjacent the optical device. The light source can be configured to produce light in a viewing zone of the optical device, such that the optical device can capture the light produced by the light source. The fluid channel can be disposed adjacent the optical device and within the viewing zone of the optical device, and the fluid channel can be configured to provide a fluid flow path. The controller is configured to store and analyze images provided by the optical device to identify characteristics of a fluid flowing through the fluid channel.

In one aspect, the fluid flows from a fluid source through a tube to the fluid channel.

In one aspect, the fluid source is one or more of a cartridge, a tube, a bag, and a syringe.

In one aspect, the fluid channel extends through a cartridge disposed adjacent the optical device and within the viewing zone of the optical device.

In one aspect, the light source is configured to produce light that illuminates the fluid channel.

In one aspect, the light produced by the light source is polarized light of any wavelength.

In one aspect, the controller includes a field programmable gate array (FPGA), a memory, and an input-output device, the controller is configured to receive images from the optical device, store the images in the memory, and analyze the images stored in the memory using the field programmable gate array.

In one aspect, the field programmable gate array analyzing the images includes detecting or identifying inner and outer edges of the fluid channel, and detecting or identifying a forwardmost fluid edge of the fluid flowing through the fluid channel.

In one aspect, the fluid analysis system is configured to analyze and control fluid transfer in a medical fluid transfer system.

In one aspect, the fluid is a liquid nutrient, liquid medication, or liquid pain reliever.

According to another aspect, a method of using a fluid analysis system to monitor and control fluid transfer is disclosed. The method can include flowing a fluid from a fluid source through a fluid channel; capturing, by an optical device, images of the fluid channel and the fluid flowing through the fluid channel; and storing and analyzing, by a controller, the images to identify characteristics of the fluid flowing through the fluid channel.

In one aspect, the characteristics of the fluid flowing through the fluid channel include one or more of a flow rate of the fluid, a forwardmost fluid edge of the fluid, and the type of fluid.

In one aspect, the method further includes producing, by a light source, light that illuminates the fluid channel and the fluid flowing through the fluid channel.

In one aspect, the method further includes capturing, by the optical device, the light produced by the light source.

In one aspect, the method further includes storing the images produced by the optical device within a memory of the controller.

In one aspect, the method further includes analyzing, by a field programmable gate array (FPGA) of the controller, the images stored within the memory of the controller.

In one aspect, the field programmable gate array analyzing the images includes detecting or identifying, by the field programmable gate array, an inner edge and an outer edge of the fluid channel; and detecting or identifying, by the field programmable gate array, a forwardmost fluid edge of the fluid flowing through the fluid channel.

In one aspect, the field programmable gate array detects or identifies the forwardmost fluid edge of the fluid flowing through the fluid channel to within 20 micrometers.

In one aspect, the method further includes graphically enhancing, by the field programmable gate array, the detected inner edge and outer edge of the fluid channel; graphically enhancing, by the field programmable gate array, the detected forwardmost fluid edge of the fluid flowing through the fluid channel; and outputting, by an input-output device of the controller, an enhanced image graphically illustrating the inner edge of the fluid channel, the outer edge of the fluid channel, and the forwardmost fluid edge of the fluid flowing through the fluid channel.

In one aspect, the fluid analysis system is configured to analyze and control fluid transfer in a medical fluid transfer system, and the fluid is a liquid nutrient, liquid medication, or liquid pain reliever.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a perspective view of a fluid analysis system according to an exemplary embodiment of the present disclosure.

FIG. 2 is a schematic block diagram of a controller of the fluid analysis system of FIG. 1.

FIG. 3A is an example of an image before and after analysis by the fluid analysis system.

FIG. 3B is another example of an image before and after analysis by the fluid analysis system.

### DETAILED DESCRIPTION OF THE PREFERRED EMBODIMENTS

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of an axle, shaft, pin, or the like. A reference to a list of items that are cited as “at least one of a, b, or c” (where a, b, and c represent the items being listed) means any single one of the items a, b, or c, or combinations thereof are included. The terms “about” and “approximately” encompass +/−10% of an indicated value unless otherwise noted. The term “generally” in connection with a radial direction encompasses +/−25 degrees. The terminology includes the words specifically noted above, derivatives thereof, and words of similar import.

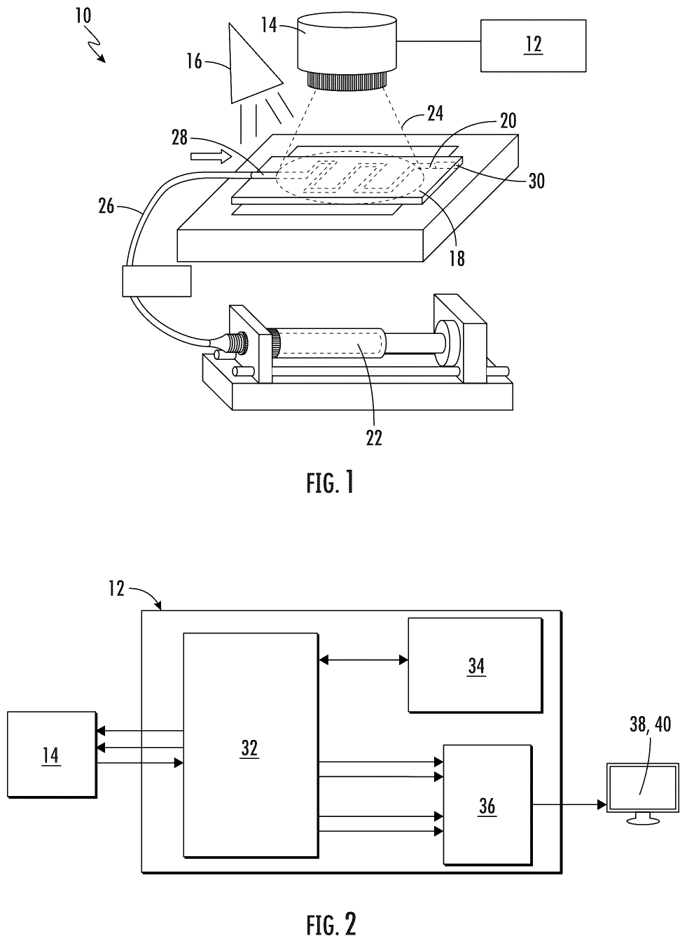

FIG. 1 is a perspective view of a fluid analysis system 10 according to an exemplary embodiment of the present disclosure. FIG. 2 is a schematic block diagram of a controller 12 of the fluid analysis system 10. FIGS. 1-2 will be discussed together. Further, hereinafter the fluid analysis system 10 will be referred to as “system 10”, but it is to be understood that the fluid analysis system 10 and the system 10 are referring to the same component/assembly.

The system 10 can be configured for monitoring and controlling fluid transfer in the medical industry. More specifically, fluids (i.e., liquids) can be transferred to a patient to administer specific fluids to improve the patients' health and to prevent pain, among other medical uses. The fluids that can be transferred include nutrients, medication, and pain relievers, among other fluids not specifically listed. The system 10 can be used to analyze and control the amount of fluid that is delivered from a fluid source 22 to a patient. In some examples, the fluid source 22 can be a cartridge, tube, bag, or syringe, among other options not specifically listed.

As illustrated in FIG. 1, the system 10 can include a controller 12, an optical device 14, a light source 16, a cartridge 18 including a fluid channel 20, and a fluid source 22. The controller 12 can be communicatively coupled to the optical device 14, such that the controller 12 can control and direct operation of the optical device 14 and the controller 12 can receive images and other data from the optical device 14 for analysis and processing, discussed further below. The optical device 14 can be a camera or other device that is configured to process light waves for viewing and analysis. More specifically, the optical device 14 can be a device capable of recording visual images in the form of photographs, film, or video signals, among other options not specifically listed.

In some examples, as illustrated, the light source 16 can be disposed adjacent the optical device 14. In other examples, the light source 16 may not be disposed adjacent the optical device 14, but somewhere else within the system 10. In any case, the light source 16 is configured to produce light in a viewing zone 24 of the optical device 14, such that the optical device 14 can capture the light produced by the light source 16. It is to be understood that the viewing zone 24 is the volume or area in which the optical device 14 can capture photographs, film, or video signals, among other options not specifically listed.

Further, it is to be understood that the light source 16 provides light that illuminates the subject matter within the viewing zone 24 of the optical device 14, to aid in gathering clearer and better images by the optical device 14. More specifically, the light source 16 is configured to produce light that illuminates the fluid channel 20 of the cartridge 18 and the fluid flowing through the fluid channel 20, discussed further below. The light source 16 can produce light in the form of polarized light, white light, or any other color light. As such, the light source 16 can produce light in the form or span of any desirable wavelength. The specific form and color of light produced by the light source 16 depends on the specific application of the overall system 10. Although not illustrated, it is to be understood that the controller 12 can be communicatively coupled to the light source 16 and the controller 12 can be configured to control and direct operation of the light source 16.

The cartridge 18 can be disposed adjacent the optical device 14, and the fluid channel 20 can extend through the cartridge 18. More specifically, the cartridge 18 can be disposed at least partially within the viewing zone 24 of the optical device 14, such that the fluid channel 20 extending through the cartridge 18 is disposed at least partially within the viewing zone 24 of the optical device 14. As such, in some examples, the fluid channel 20 can be described as being disposed adjacent the optical device 14 and within the viewing zone 24 of the optical device 14. As illustrated in FIG. 1, the fluid channel 20 can extend through the cartridge 18 in a curvy, wavy, or otherwise non-straight manner from one end of the cartridge 18 to the other end of the cartridge 18. In other non-illustrated examples, the fluid channel 20 can extend through the cartridge 18 in a straight line extending from one end of the cartridge 18 to the other end of the cartridge 18. The fluid channel 20 is adapted to provide a fluid flow path for a fluid (i.e., a liquid) to flow through from one end of the cartridge 18 to the other end of the cartridge 18, discussed further below.

It is to be understood that although the fluid channel 20 is illustrated and described as extending through the cartridge 18, in other embodiments the fluid channel 20 could be a stand-alone tube, pipe, or other fluid transfer device that provides a conduit for fluid to flow through. As such, the system 10 is not limited specifically to a fluid channel 20 extending through a cartridge 18. The aforementioned is an example embodiment, and it is to be understood that other non-illustrated embodiments could differ. As such, in some examples, the fluid channel 20 could be a stand-alone tube, pipe, or other fluid transfer device that is disposed at least partially within the viewing zone 24 of the optical device 14. Further, in such examples, the fluid channel 20 (stand-alone tube, pipe, or other fluid transfer device) could include a straight, curved, or wavy shape or configuration.

In addition, the system 10 can include a fluid source 22 that is fluidly coupled to the fluid channel 20 through a tube 26 extending and fluidly coupled between the fluid source 22 and the fluid channel 20. As such, a fluid (i.e., liquid) can flow from the fluid source 22, through the tube 26, and to a fluid input 28 of the fluid channel 20. The fluid can then flow from the fluid input 28 of the fluid channel 20 through the fluid channel 20 to a fluid output 30 of the fluid channel 20. Although not illustrated, it is to be understood that the fluid output 30 could be coupled to another tube or other fluid transfer device to allow the fluid to flow to a patient or component/device separate from the system 10. As discussed, the fluid source 22 can be a cartridge, tube, bag, or syringe, among other options not specifically listed, that is adapted for storing and holding fluids, such as liquids. More specifically, the fluid source 22 can be any device or component that is adapted to store and hold liquid nutrients, liquid medication, and liquid pain relievers, among other medical and non-medical liquids not specifically listed.

The disclosed system 10 can be configured for monitoring and controlling fluid transfer in the medical industry. Although the disclosure focuses on an example in which the system 10 is utilized in the medical industry, it will be appreciated by persons having skill in the art that the disclosed system 10 can be utilized for non-medical applications, such as the industrial fluid transfer industry. With that said, the following disclosure will specifically focus on an example in which the system 10 is utilized in the medical industry to monitor and control fluid transfer. More specifically, the system 10 can monitor and control the transfer of fluids (i.e., liquids) from the fluid source 22 to a patient. As such, the optical device 14, light source 16, and fluid channel 20 can each be positioned at a location between the fluid source 22 and the user/patient in which the fluid is to be administered. Further, the system 10 is configured to monitor the fluid flowing through the fluid channel 20 to identify characteristics of the fluid flowing through the fluid channel 20, such as at least the fluid flow rate, a forwardmost fluid edge of the fluid, and the type of fluid flowing through the fluid channel 20, discussed further below.

As discussed, FIG. 2 is a simplified schematic block diagram of some of the internal components of the controller 12 of the system 10. The controller 12 can include at least a field programmable gate array (FPGA) 32, a memory 34, and an input-output device 36. As discussed, the controller 12 can be communicatively coupled to the optical device 14, and the controller 12 can be configured to control operation of the optical device 14 as well as receive images and other data from the optical device 14. Further, as illustrated, the controller 12 can be communicatively coupled to a display 38 and/or an output device 40. In some examples, the display 38 and/or the output device 40 can be formed integral with the controller 12, such that the controller 12 and the display 38 and/or the output device 40 are each a component of an overall assembly (i.e., a computer or computer system). In other examples, the display 38 and/or the output device 40 can be separate components from the controller 12 that are disposed and positioned remote from the controller 12. In either example, the display 38 and/or the output device 40 can be configured to display and/or transfer data collected and analyzed by the system 10 for a user's viewing, analysis, and interpretation.

The FPGA 32 can be communicatively coupled to each of the memory 34 and the input-output device 36, such that data can transfer between the FPGA 32 and the memory 34 and between the FPGA 32 and the input-output device 36. The FPGA 32 is a circuit integrated in the controller 12 that is configured to identify characteristics of the fluid flowing through the fluid channel 20. More specifically, the FPGA 32 is the component of the controller 12 that is adapted and specifically designed for advanced processing and analysis of the images captured, recorded, and provided by the optical device 14 to identify characteristics of the fluid flowing through the fluid channel 20, discussed further below.

The memory 34 is the component of the controller 12 that is adapted for storing the images captured, recorded, and provided by the optical device 14. As such, the images captured, recorded, and provided by the optical device 14 are transferred from the optical device 14 to the controller 12, and then stored within the memory 34 of the controller 12 for processing by the FPGA 32. The input-output device 36 is a component of the controller 12 that can be configured to transfer data collected by the controller 12 to a device separate and remote from the controller 12 and/or the overall system 10. In some examples, the input-output device 36 can transfer data collected by the controller 12 through one or more of a hard wired/cabled connection, a wireless network protocol (Wi-Fi), a cellular signal, a Bluetooth standard, and a cloud-based data transfer service, among other options not specifically listed. Further, in some examples, the input-output device 36 can be configured to transfer data to the display 38 and/or the output device 40 to display the data for a user's viewing, analysis, and interpretation.

In operation, the controller 12 can send a signal to the optical device 14 to activate the optical device 14, such that the optical device 14 begins capturing and recording images within the viewing zone 24 of the optical device 14. In addition, or simultaneously, the controller 12 can send a signal to the light source 16 to activate the light source 16, such that the light source 16 produces light that illuminates the portion of the fluid channel 20 disposed within the viewing zone 24 of the optical device 14. Next, the fluid source 22 can be opened or activated to cause fluid to flow from the fluid source 22, through the tube 26, and into the fluid input 28 of the fluid channel 20. The fluid can enter the fluid input 28 of the fluid channel 20 and then flow through the fluid channel 20 from the fluid input 28 to the fluid output 30 of the fluid channel 20.

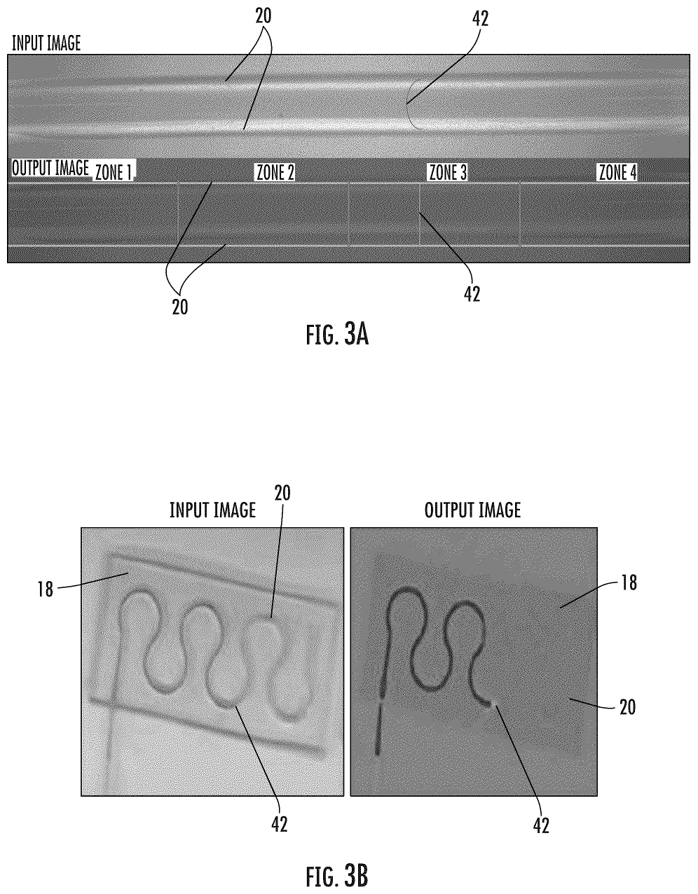

As the fluid flows through the fluid channel 20, the optical device 14 continuously records or captures images of the fluid channel 20 and the fluid flowing through the fluid channel 20 within the viewing zone 24 of the optical device 14. The images that are recorded and captured by the optical device 14 are transferred from the optical device 14 to the controller 12, where the images are stored within the memory 34 of the controller 12. Once the images have been stored within the memory 34 of the controller 12, the FPGA 32 can access and analyze the images stored within the memory 34 of the controller 12, discussed further with reference to FIGS. 3A-3B.

FIG. 3A is an example of an image before (input image) and after (output image) analysis by the FPGA 32 of the system 10. FIG. 3B is another example of an image before (input image) and after (output image) analysis by the FPGA 32 of the system 10. FIGS. 3A-3B will be discussed together. During analysis by the FPGA 32, the FPGA 32 can utilize advanced processing software/code to detect or identify inner and outer edges of the fluid channel 20 to accurately identify the shape and size of the fluid channel 20. Further, during analysis by the FPGA 32, the FPGA 32 can utilize advanced processing software/code to detect or identify a forwardmost fluid edge 42 (FIG. 3A) of the fluid flowing through the fluid channel 20. In some examples, the FPGA 32 can detect or identify the inner and outer edges of the fluid channel 20 and the forwardmost fluid edge 42 of the fluid flowing through the fluid channel 20 to within 20 micrometers of accuracy.

In addition, after analysis by the FPGA 32 of the images from the optical device 14, the FPGA 32 can graphically enhance the images or results output by the FPGA 32. More specifically, after analysis by the FPGA 32 of the images from the optical device 14, the FPGA 32 can graphically enhance the detected inner and outer edges of the fluid channel 20, and the FPGA 32 can also graphically enhance the detected forwardmost fluid edge 42 of the fluid flowing through the fluid channel 20 to improve the quality of the images or results output by the FPGA 32. The FPGA 32 can then store the output images or results within the memory 34 of the controller 12, and the FPGA 32 can send the output images or results to the input-output device 36. The input-output device 36 of the controller 12 can then output the results and/or enhanced image graphically regarding the inner and outer edges of the fluid channel 20 and the forwardmost fluid edge 42 of the fluid flowing through the fluid channel 20 to the display 38 and/or the output device 40 for a user's viewing, analysis, and interpretation.

As illustrated in FIGS. 3A-3B, the FPGA 32 can receive input (raw) images from the optical device 14 and/or memory 34, and then the FPGA 32 can identify the inner and outer edges of the fluid channel 20 to determine the area/volume of the fluid channel 20 in which fluid flows through. Then the FPGA 32 can determine when fluid enters the viewing zone 24 by identifying the forwardmost fluid edge 42 of the fluid flowing through the fluid channel 20 within the viewing zone 24. After the forwardmost fluid edge 42 has been identified by the FPGA 32, the FPGA 32 can then track the forwardmost fluid edge 42 of the fluid as it flows through the fluid channel 20 to determine characteristics of the fluid, such as flow rate, density, viscosity, etc. The characteristics of the fluid can then be utilized to determine the amount of fluid that is being dispensed, and the overall system 10 can adjust the flow rate of the fluid flowing through the fluid channel 20 to ensure the desired amount of fluid is being dispensed.

The input images illustrated in FIGS. 3A-3B represent the raw image that the FPGA 32 receives from the optical device 14 and/or the memory 34. The output images illustrated in FIGS. 3A-3B represent the images/results output by the FPGA 32 after analysis of the raw images by the FPGA 32. It will be appreciated by those skilled in the art that the results ultimately output by the FPGA 32 and the overall system 10 may not necessarily be images or figures of the fluid flowing through the fluid channel 20. Rather, the FPGA 32 can output results in numerical form indicating the analyzed and calculated characteristics (forwardmost fluid edge 42, fluid flow rate, fluid density, fluid viscosity, etc.) of the fluid flowing through the fluid channel 20, such that a user (physician, technician, etc.) of the data can quickly read the results to determine if the correct amount of fluid is being dispensed and/or if the amount of fluid being dispensed needs to be adjusted.

The system 10 allows low cost remote monitoring of liquid transfer in medical devices such as diagnostic systems and infusion pumps. By utilizing the controller 12, optical device 14, and light source 16, the system 10 can detect the transfer of fluid in a transparent tube or cartridge. Further, the system 10 can detect the arrival of liquids (including transparent liquids) in the fluid channel 20 to compute one or more of a flow rate of the fluid, a forwardmost fluid edge 42 of the fluid, and other characteristics (density, viscosity, etc.) of the fluid flowing through the fluid channel 20. As such, the data output by the system 10 can be utilized to ensure the correct amount (i.e., volume) of fluid is being dispensed to the patient or end user of the fluid. Further, the system 10 includes a high-degree of automation which results in an overall efficient fluid transfer system 10, compared to previous approaches and solutions.

In the medical industry, it is desirable to avoid physical contact with the fluid to be dispensed, while at the same time it is necessary to measure characteristics of the fluid flowing through the system 10. The disclosed system 10 can replace the existing solutions that require electrical connection to the cartridge electrodes and the implementation of electrodes in the disposable fluid source, and the system 10 can utilize the optical device 14 and the controller 12 to determine the fluid characteristics which previously required direct electrical connections. In addition, the system 10 can replace the existing ultrasound sensors currently used for the detection of tubes, such as for infusion pumps, etc.

The disclosed system 10 provides many advantages over existing fluid (liquid) transfer monitoring systems for medical devices, as will be appreciated by those skilled in the art. The system 10 is modular and is easy to install due to only requiring simple optical alignment of the optical device 14, compared to cartridge electrode based solutions. Further, the system 10 reduces the overall cost of liquid transfer monitoring systems for medical devices due to the removal of disposable printed carbon electrodes in the cartridge (i.e., fluid source) and because no electrical connection to the cartridge is required for operation. The system 10 including the controller 12 with the FPGA 32 provides a solution with lower latency and is easy to update, compared to previous solutions. In addition, the system 10 is customizable and can be integrated in various orientations and positions within a user's liquid transfer device. Compared to previous solutions, the system 10 is more reliable because there is no deterioration of connectors connected to the electrodes because the system 10 does not include electrodes or connectors in direct contact with the fluid to be transferred. Lastly, the system 10 has commonality, meaning the FPGA 32 of the system 10 can utilize the same algorithm for a fluid channel 20, a cartridge 18, a tube, or any other fluid conduit, and the system 10 can analyze the images and output accurate data relating to the characteristics of the fluid flow. The aforementioned advantages are only some of the advantages provided by the system 10, and persons having ordinary skill in the art will appreciate the many other advantages of the disclosed system 10.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

What is claimed is:

1. A fluid analysis system for analyzing and controlling fluid transfer, the fluid analysis system comprising:
a controller communicatively coupled to an optical device;
a light source disposed adjacent the optical device, the light source being configured to produce light in a viewing zone of the optical device, such that the optical device can capture the light produced by the light source; and
a fluid channel disposed adjacent the optical device and within the viewing zone of the optical device, the fluid channel being configured to provide a fluid flow path;
wherein the controller is configured to store and analyze images provided by the optical device to identify characteristics of a fluid flowing through the fluid channel.

2. The fluid analysis system of claim 1, wherein the fluid flows from a fluid source through a tube to the fluid channel.

3. The fluid analysis system of claim 2, wherein the fluid source is one or more of a cartridge, a tube, a bag, and a syringe.

4. The fluid analysis system of claim 1, wherein the fluid channel extends through a cartridge disposed adjacent the optical device and within the viewing zone of the optical device.

5. The fluid analysis system of claim 1, wherein the light source is configured to produce light that illuminates the fluid channel.

6. The fluid analysis system of claim 5, wherein the light produced by the light source is polarized light of any wavelength.

7. The fluid analysis system of claim 1, wherein the controller comprises a field programmable gate array (FPGA), a memory, and an input-output device, wherein the controller is configured to receive images from the optical device, store the images in the memory, and analyze the images stored in the memory using the field programmable gate array.

8. The fluid analysis system of claim 7, wherein the field programmable gate array analyzing the images comprises:
detecting or identifying inner and outer edges of the fluid channel; and
detecting or identifying a forwardmost fluid edge of the fluid flowing through the fluid channel.

9. The fluid analysis system of claim 1, wherein the fluid analysis system is configured to analyze and control fluid transfer in a medical fluid transfer system.

10. The fluid analysis system of claim 1, wherein the fluid is a liquid nutrient, liquid medication, or liquid pain reliever.

11. A method of using a fluid analysis system to monitor and control fluid transfer, the method comprising:
flowing a fluid from a fluid source through a fluid channel;
capturing, by an optical device, images of the fluid channel and the fluid flowing through the fluid channel; and
storing and analyzing, by a controller, the images to identify characteristics of the fluid flowing through the fluid channel.

12. The method of claim 11, wherein the characteristics of the fluid flowing through the fluid channel include one or more of a flow rate of the fluid, a forwardmost fluid edge of the fluid, and the type of fluid.

13. The method of claim 11, further comprising producing, by a light source, light that illuminates the fluid channel and the fluid flowing through the fluid channel.

14. The method of claim 13, further comprising capturing, by the optical device, the light produced by the light source.

15. The method of claim 11, further comprising storing the images produced by the optical device within a memory of the controller.

16. The method of claim 15, further comprising analyzing, by a field programmable gate array (FPGA) of the controller, the images stored within the memory of the controller.

17. The method of claim 16, wherein the field programmable gate array analyzing the images comprises:
detecting or identifying, by the field programmable gate array, an inner edge and an outer edge of the fluid channel; and
detecting or identifying, by the field programmable gate array, a forwardmost fluid edge of the fluid flowing through the fluid channel.

18. The method of claim 17, wherein the field programmable gate array detects or identifies the forwardmost fluid edge of the fluid flowing through the fluid channel to within 20 micrometers.

19. The method of claim 17, further comprising:
graphically enhancing, by the field programmable gate array, the detected inner edge and outer edge of the fluid channel;
graphically enhancing, by the field programmable gate array, the detected forwardmost fluid edge of the fluid flowing through the fluid channel; and
outputting, by an input-output device of the controller, an enhanced image graphically illustrating the inner edge of the fluid channel, the outer edge of the fluid channel, and the forwardmost fluid edge of the fluid flowing through the fluid channel.

20. The method of claim 11, wherein the fluid analysis system is configured to analyze and control fluid transfer in a medical fluid transfer system, and wherein the fluid is a liquid nutrient, liquid medication, or liquid pain reliever.
